(19) United States
(12) Patent Application Publication
(10) Pub. No.: US 2023/0182686 A1
(43) Pub. Date: Jun. 15, 2023

(54) PUSH BUTTON/MICROPHONE COMBO AND KEY FOB SPEECH RECOGNITION SYSTEM

(71) Applicant: Panasonic Automotive Systems Company of America, Division of Panasonic Corporation of North America, PEACHTREE CITY, GA (US)

(72) Inventors: KATHERINE FREUND, LIVONIA, MI (US); JOHN SCOTT SIEGEL, ROCHESTER HILLS, MI (US)

(21) Appl. No.: 18/076,440

(22) Filed: Dec. 7, 2022

Related U.S. Application Data
(60) Provisional application No. 63/287,880, filed on Dec. 9, 2021.

(51) Int. Cl. B60R 25/25; G10L 17/22; B60R 25/24; B60R 25/01

(52) U.S. Cl. CPC B60R 25/257; G10L 17/22; B60R 25/24; B60R 25/01

(57) ABSTRACT

A key fob for controlling operation of a motor vehicle includes a pushbutton that responds to being pushed by causing a signal to be transmitted to the motor vehicle. The signal requests that the motor vehicle perform a predetermined operation. The key fob includes a microphone detecting audible speech from a user and transmitting a signal based on the detected speech to an automatic speech recognition system such that the automatic speech recognition system can recognize in the signal a request that the motor vehicle perform the predetermined operation.

### CROSS-REFERENCED TO RELATED APPLICATIONS

This application claims benefit of U.S. Provisional Application No. 63/287880, filed on Dec. 9, 2021, the disclosure of which is hereby incorporated by reference in its entirety for all purposes.

### BACKGROUND OF THE INVENTION

### 1. Field of the Invention

The present invention relates to a system for opening a lift gate of a motor vehicle.

### 2. Description of the Related Art

Currently, many vehicles are equipped with an exterior push button to open the lift gate. However, users may need a hands-free way to issue commands while approaching the vehicle, such as when their arms are full of groceries, or when they are holding a child.

Current hands-free speech recognition solutions within a vehicle require elaborate smart-home setups. This requires a lot of technology overhead and is complicated for the user to set up.

Alternatively, there is a “kick gate” that allows users to open the trunk by waving their foot under the rear of the car. However, the accuracy of the kick gate is low and it still requires users to be immediately behind the vehicle.

### SUMMARY OF THE INVENTION

Adding voice recognition as a way to open the lift gate requires adding an exterior microphone. Options for adding an exterior microphone include putting another hole in the panel for a microphone, but pulling a tool to add this feature is expensive. If the microphone is optional, an additional part would have to be installed to cover the opening if the microphone is not desired. Another option is to replace the push button with a microphone, but this results in losing the push button functionality. The present invention may solve both of the above issues by reusing the existing push button opening while keeping the push button functionality.

In one embodiment, the present invention may combine an exterior microphone and an exterior push button into one module. One of its uses is to enable opening a vehicle lift gate by either pushing the button or using voice recognition.

In another embodiment, the present invention may provide a speech recognition system housed within a vehicle key fob. The speech recognition system may include one or more microphones and a speech recognition library. This system may communicate user issued voice commands, such as “open trunk” or “lock doors”. A vehicle-mounted microphone may have a degraded signal-to-noise ratio (SNR) over distance, while a fob may stay with the user and thus provide a higher quality voice signal. A speech recognition solution in the fob may simplify the automatic speech recognition (ASR) experience while enabling the user to interact with the car from a distance.

In yet another embodiment, the ASR system may be in the user's phone via an app.

In a further embodiment, the user may press a button on the fob to initialize speech recognition. This may serve to decrease false triggers or a degraded voice path if the fob were to be located in a pocket or purse.

In still another embodiment, microphones may be installed in both the vehicle and the fob in order to provide increased speech coverage.

In another embodiment, the vehicle may not require fob detection. Thus, the user may interact with the car on behalf of a third party who needs access to the vehicle. For example, there may be a delivery, or a family may be locked out of the vehicle.

In yet another embodiment, users may “summon” their autonomous car to their location. In response to having its button pushed, the fob may wake up the autonomous car, give the car the location of the user and a destination, and command the car to drive to the user.

The invention comprises, in one form thereof, a key fob for controlling operation of a motor vehicle. The key fob includes a pushbutton that responds to being pushed by causing a signal to be transmitted to the motor vehicle. The signal requests that the motor vehicle perform a predetermined operation. The key fob includes a microphone detecting audible speech from a user and transmitting a signal based on the detected speech to an automatic speech recognition system such that the automatic speech recognition system can recognize in the signal a request that the motor vehicle perform the predetermined operation.

The invention comprises, in another form thereof, a method for controlling operation of a motor vehicle, including providing a key fob having a pushbutton and a microphone. In response to the pushbutton of the key fob being pushed, a signal is transmitted to the motor vehicle. The signal requests that the motor vehicle perform a predetermined operation. The microphone detects audible speech from a user. A signal is transmitted from the key fob based on the detected speech to an automatic speech recognition system such that the automatic speech recognition system can recognize in the signal a request that the motor vehicle perform the predetermined operation.

The invention comprises, in yet another form thereof, a system for controlling operation of a motor vehicle. The system includes a pushbutton responding to being pushed by causing a signal to be transmitted to the motor vehicle. The signal requests that the motor vehicle perform a predetermined operation. A microphone detects audible speech from a user, and transmits a signal based on the detected speech. An automatic speech recognition system receives the signal, and recognizes in the signal a request that the motor vehicle perform the predetermined operation. In response to the recognition of the request, the automatic speech recognition system causes the motor vehicle to perform the predetermined operation.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is an exploded front perspective view of one embodiment of a pushbutton/microphone combo system of the present invention.

FIG. 2 is a front perspective view of the pushbutton/microphone combo assembly and female connector of the pushbutton/microphone combo system of FIG. 1.

FIG. 3 is a rear view of the pushbutton/microphone combo assembly of FIG. 2.

FIG. 4 is a side view of the pushbutton/microphone combo assembly of FIG. 3 along lines 4-4.

FIG. 5 is a bottom view of the pushbutton/microphone combo assembly of FIG. 3 along lines 5-5.

FIG. 6 is a perspective view of another embodiment of a pushbutton/microphone combo assembly and female connector of the present invention.

FIG. 7 is an exploded perspective view of the pushbutton/microphone combo assembly and female connector of FIG. 6.

FIG. 8 is a rear view of a motor vehicle suitable for having a pushbutton/microphone combo system of the present invention installed thereon.

FIG. 9 is a side view of the motor vehicle of FIG. 8 along lines 9-9.

FIG. 10 is an enlargement of area B of FIG. 9.

FIG. 11 is a flow chart of one embodiment of a method of the present invention for opening and/or closing a lift gate of a motor vehicle.

FIG. 12 is a flow chart of one embodiment of a method of the present invention for controlling operation of a motor vehicle.

FIG. 13 is a block diagram of one embodiment of a system of the invention for controlling operation of a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

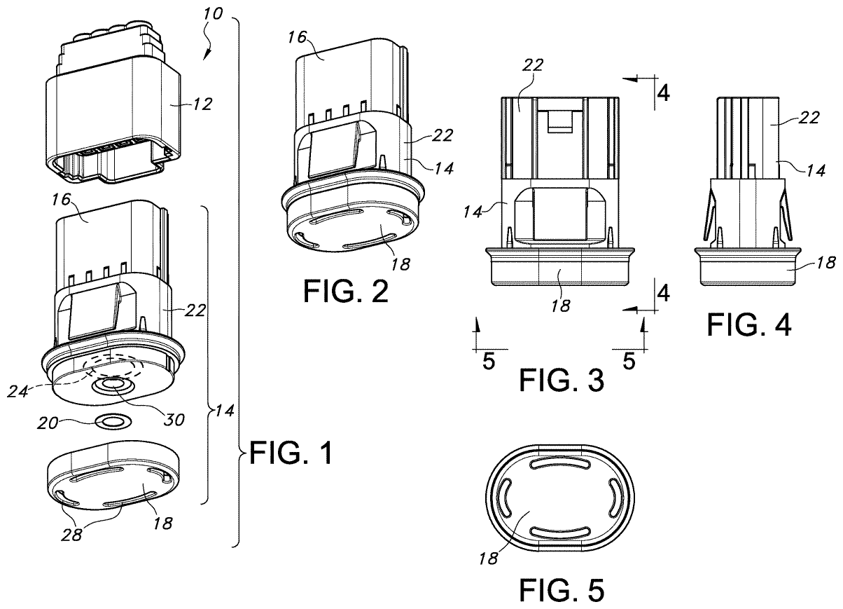

FIG. 1 illustrates a one embodiment of a pushbutton/microphone combo system 10 of the present invention which may be included in a key fob. System 10 includes a four-pin water-tight connector 12 and a pushbutton/microphone combo assembly 14 coupled to a female connector 16. Pushbutton/microphone combo assembly 14 includes a water-shedding cover 18, a self-adhesive hydrophobic acoustically transparent membrane 20, and a pushbutton/microphone combo subassembly 22. Pushbutton/microphone combo subassembly 22 includes a pushbutton or tactile switch 24 and a microphone 30 that are only schematically indicated in FIG. 1. Cover 18 includes microphone openings 28.

FIG. 2 illustrates pushbutton/microphone combo assembly 14 in its assembled state, and when connected to female connector 16. FIG. 3 illustrates the rear of pushbutton/microphone combo assembly 14 of FIG. 2. FIG. 4 illustrates the side of the pushbutton/microphone combo assembly 14 of FIG. 2. FIG. 5 illustrates the bottom of pushbutton/microphone combo assembly 14.

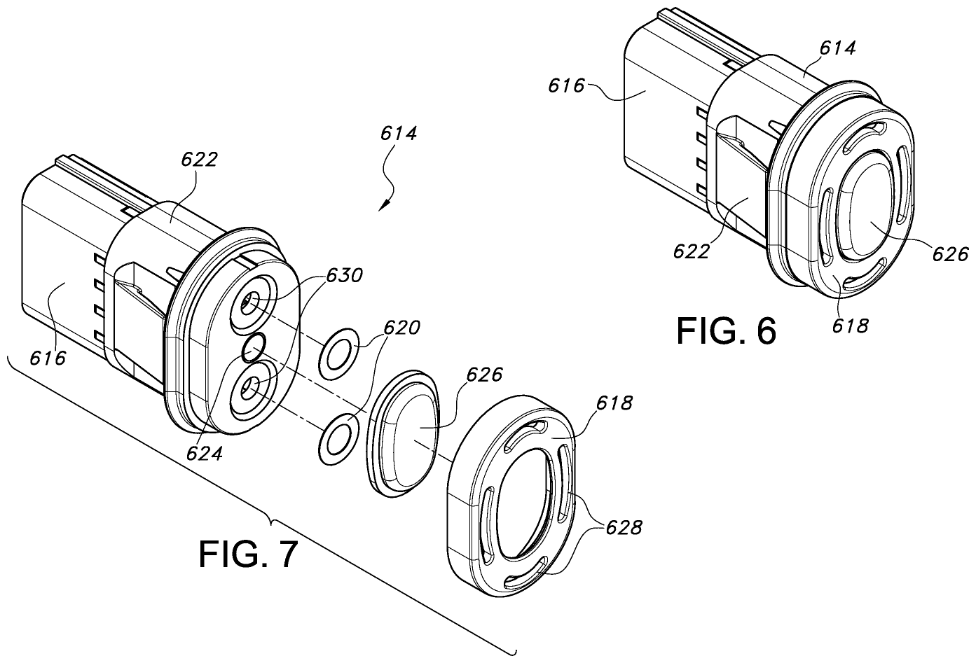

FIG. 6 illustrates another embodiment of a pushbutton/microphone combo assembly 614 and 616 female connector of the present invention which may be included in a key fob. Pushbutton/microphone combo assembly 614 includes a pushbutton/microphone combo subassembly 622, a pushbutton 626 and a cover 618 with microphone openings 628.

FIG. 7 illustrates pushbutton/microphone combo assembly 614 and female connector 616 in an exploded view. Pushbutton/microphone combo assembly 614 further includes self-adhesive hydrophobic membranes 620, a tactile switch 624, and two microphones 630.

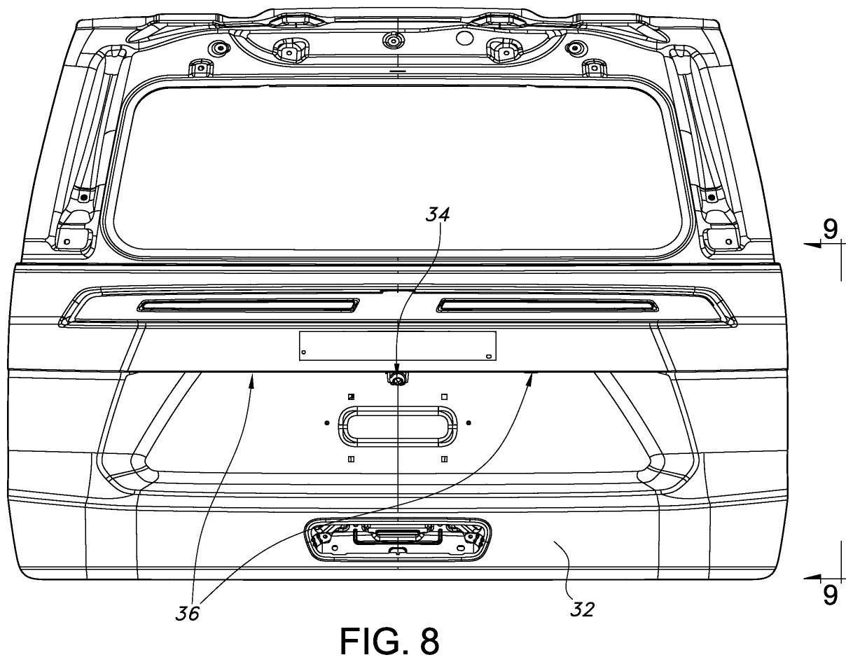

FIG. 8 illustrates a motor vehicle 32 suitable for having a pushbutton/microphone combo system of the present invention installed thereon. A suitable location for a pushbutton/microphone combo system in a single microphone scenario is shown at 34. Suitable locations for two pushbutton/microphone combo systems in a double microphone scenario are shown at 36.

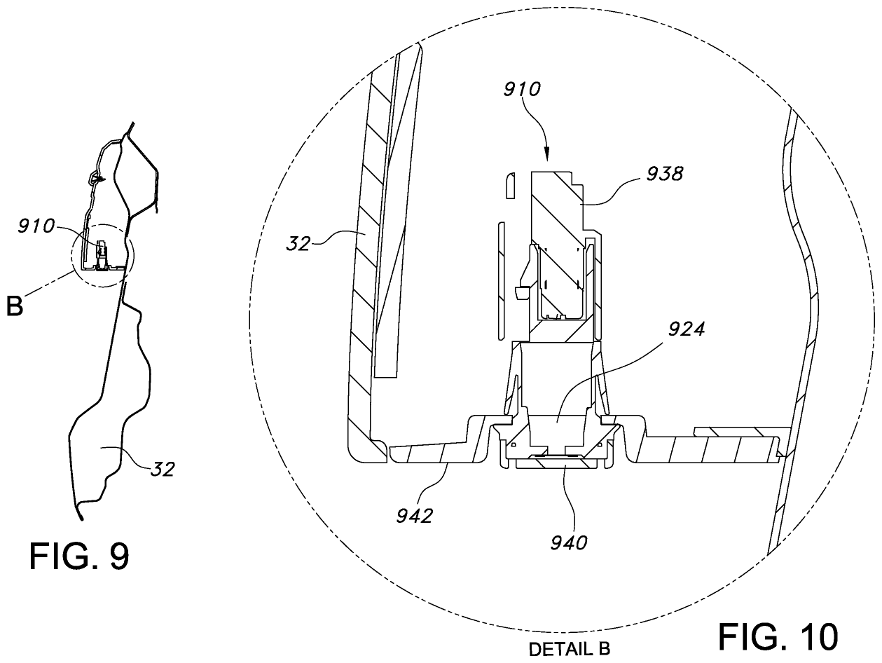

FIG. 9 illustrates the possible placement of a of the present invention on motor vehicle 32. As shown in the enlarged view of FIG. 10, pushbutton/microphone combo system 910 includes a tactile switch 924, a wire harness 938, and a microphone assembly 940 behind a license plate applique 942.

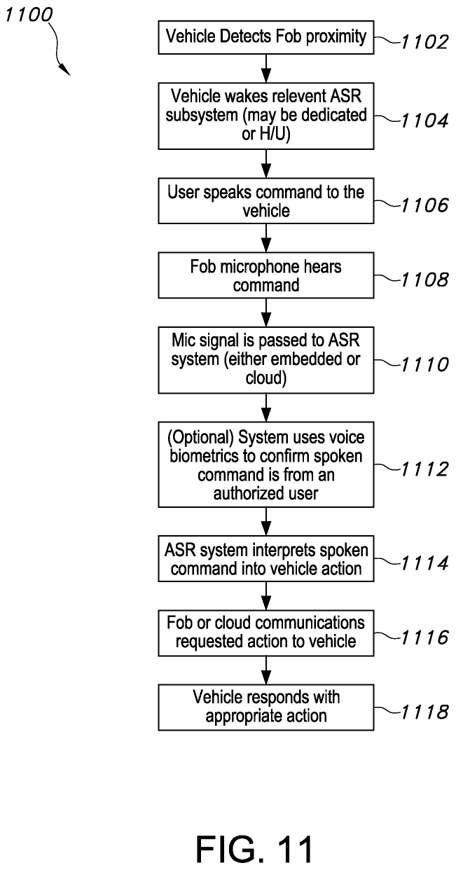

FIG. 11 is a flow chart of one embodiment of a method 1100 of the present invention for opening and/or closing a lift gate of a motor vehicle. In a first step 1102, a vehicle detects a fob in close proximity. For example, a user may press a pushbutton on his fob, which causes a wireless signal to be transmitted to the vehicle. By virtue of receiving the wireless signal, the vehicle may detect that a fob is nearby.

Next, in step 1104, the vehicle wakes up a relevant automatic speech recognition (ASR) subsystem, which may be a dedicated subsystem or a subsystem that is hooked up via the cloud. For example, the vehicle may wake up an ASR system that is on the fob or on the vehicle. Alternatively, the ASR system may be operated on a server at a remote location.

In a next step 1106, the user speaks a command to the vehicle. For example, the user may say a command to the vehicle into his key fob.

In step 1108, a microphone in the fob hears the command. For example, there may be a microphone on the fob that detects the audible speech from the user.

Next, in step 1110, a signal from the microphone is passed to the ASR system, which may be embedded in the fob, in the vehicle, or disposed in the cloud. For example, the microphone may convert the audible speed into an electronic signal. The electronic signal may be transmitted to an ASR system in the fob. Alternatively, the electronic signal may be wirelessly transmitted to an ASR system in the vehicle. As another alternative, the vehicle may wirelessly transmit the received signal to an ASR system that is disposed at a remote location.

In a next step 1112, the system uses voice biometrics to confirm that the spoken command is from an authorized user. For example, a biometric system in the fob, in the vehicle, or at a remote location may determine and/or confirm that the voice spoken into the fob is the voice of a user who has permission to issue commands.

In step 1114, the ASR system interprets the spoken command into a vehicle action. For example, the ASR system may interpret the spoken command as a command to open the rear gate.

Next, in step 1116, the fob or the cloud communicates a requested action to the vehicle. For example, if the ASR system is located in the fob or the cloud, the ASR system transmits a wireless signal to the vehicle requesting that the rear gate be opened.

In a final step 1118, the vehicle responds to the requested action with an appropriate action. For example, the vehicle may respond to the request that the rear gate be opened by opening the gate.

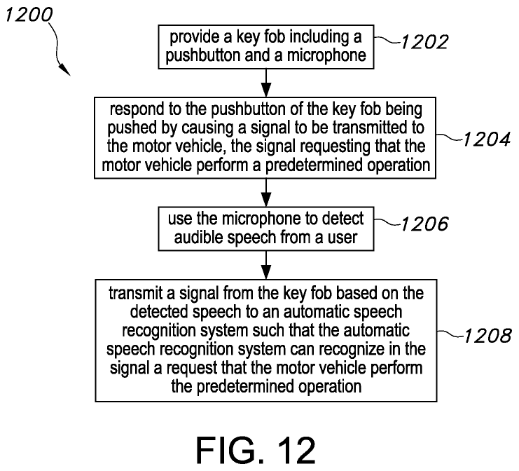

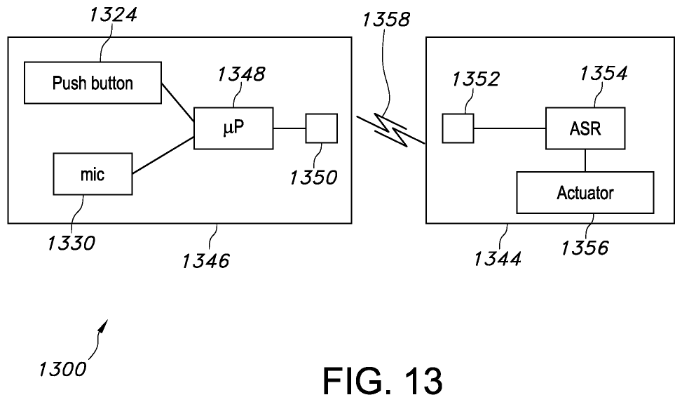

FIG. 12 illustrates one embodiment of a method 1200 of the present invention for controlling operation of a motor vehicle, which may be described herein with reference to FIG. 13. FIG. 13 illustrates one embodiment of a system 1300 for controlling operation of a motor vehicle 1344. System 1300 includes a key fob 1346 having a pushbutton 1324, a microphone 1330, an electronic processor 1348, and a transmitter 1350. Motor vehicle 1344 includes a receiver 1352, an automatic speech recognition system or module 1354, and an actuator 1356.

In a first step 1202 of method 1200, a key fob including a pushbutton and a microphone is provided. For example, key fob 1346 may be provided including a pushbutton 1324 and a microphone 1330.

Next, in step 1204, in response to the pushbutton of the key fob being pushed, a signal is caused to be transmitted to the motor vehicle, the signal requesting that the motor vehicle perform a predetermined operation. For example, in response to pushbutton 1324 of key fob 1346 being pushed, processor 1348 may cause a signal to be wirelessly transmitted from transmitter 1350 of key fob 1346 to receiver 1352 of motor vehicle 1344, as indicated at 1358. The signal may request that the motor vehicle unlock its driver's door.

In a next step 1206, the microphone is used to detect audible speech from a user. For example, microphone 1330 may detect audible speech by a human user and convert the speech into an electronic microphone signal.

In a final step 1208, a signal based on the detected speech is transmitted from the key fob to an automatic speech recognition system such that the automatic speech recognition system can recognize in the signal a request that the motor vehicle perform the predetermined operation. For example, the electronic microphone signal based on the detected speech is transmitted from transmitter 1350 of key fob 1346 to automatic speech recognition system 1354 via receiver 1352. Automatic speech recognition system 1354 can recognize in the microphone signal a request that motor vehicle 1344 unlock a door of vehicle 1344. Automatic speech recognition system 1354 may then send a signal to actuator 1356 to cause actuator 1356 to unlock the vehicle door.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A key fob for controlling operation of a motor vehicle, the key fob comprising:
a pushbutton configured to respond to being pushed by causing a signal to be transmitted to the motor vehicle, the signal requesting that the motor vehicle perform a predetermined operation; and
a microphone configured to:
detect audible speech from a user; and
transmit a signal based on the detected speech to an automatic speech recognition system such that the automatic speech recognition system can recognize in the signal a request that the motor vehicle perform the predetermined operation.

2. The key fob of claim 1 wherein the predetermined operation comprises opening a gate of the motor vehicle.

3. The key fob of claim 1 wherein the automatic speech recognition system is disposed in the key fob.

4. The key fob of claim 1 wherein the automatic speech recognition system is disposed in the motor vehicle.

5. The key fob of claim 1 wherein the automatic speech recognition system is disposed at a location that is remote from the key fob and from the motor vehicle.

6. The key fob of claim 1 wherein the key fob is configured to inform the motor vehicle that the key fob is nearby.

7. The key fob of claim 1 wherein the key fob includes a voice biometrics system configured to determine whether the audible speech from the user is from an authorized user.

8. A method for controlling operation of a motor vehicle, the method comprising:
providing a key fob including a pushbutton and a microphone;
responding to the pushbutton of the key fob being pushed by causing a signal to be transmitted to the motor vehicle, the signal requesting that the motor vehicle perform a predetermined operation;
using the microphone to detect audible speech from a user; and
transmitting a signal from the key fob based on the detected speech to an automatic speech recognition system such that the automatic speech recognition system can recognize in the signal a request that the motor vehicle perform the predetermined operation.

9. The method of claim 8 wherein the predetermined operation comprises opening a gate of the motor vehicle.

10. The method of claim 8 wherein the automatic speech recognition system is disposed in the key fob.

11. The method of claim 8 wherein the automatic speech recognition system is disposed in the motor vehicle.

12. The method of claim 8 wherein the automatic speech recognition system is disposed at a location that is remote from the key fob and from the motor vehicle.

13. The method of claim 8 wherein the key fob informs the motor vehicle that the key fob is nearby.

14. The method of claim 8 wherein the key fob includes a voice biometrics system that determines whether the audible speech from the user is from an authorized user.

15. A system for controlling operation of a motor vehicle, the system comprising:
a pushbutton configured to respond to being pushed by causing a signal to be transmitted to the motor vehicle, the signal requesting that the motor vehicle perform a predetermined operation;
a microphone configured to:
detect audible speech from a user; and
transmit a signal based on the detected speech; and
an automatic speech recognition system configured to:
receive the signal;
recognize in the signal a request that the motor vehicle perform the predetermined operation; and
in response to the recognition of the request, cause the motor vehicle to perform the predetermined operation.

16. The system of claim 15 wherein the pushbutton and the microphone are disposed in a same housing.

17. The system of claim 16 wherein the housing is attached to a gate of the motor vehicle, and the predetermined operation comprises opening the gate of the motor vehicle.

18. The system of claim 15 wherein the automatic speech recognition system is disposed in the motor vehicle.

19. The system of claim 15 wherein the automatic speech recognition system is disposed at a location that is remote from the motor vehicle.

20. The system of claim 15 further comprising a voice biometrics system configured to determine whether the audible speech from the user is from an authorized user.

21. The system of claim 15 wherein the pushbutton and the microphone are attached to a gate of the motor vehicle.

22. The system of claim 22 wherein the predetermined operation comprises opening the gate of the motor vehicle.
